(19) United States
(12) Patent Application Publication
(10) Pub. No.: US 2019/0331150 A1
(43) Pub. Date: Oct. 31, 2019

(54) SCREW FASTENING APPARATUS, FRAME

(71) Applicant: KYOCERA Document Solutions Inc., Osaka (JP)

(72) Inventors: Minoru Shinba, Osaka (JP); Yuichi Sugiyama, Osaka (JP)

(21) Appl. No.: 16/392,850

(22) Filed: Apr. 24, 2019

(30) Foreign Application Priority Data
Apr. 27, 2018 (JP) 2018-086579

(51) Int. Cl. F16B 23/00; B25B 13/48

(52) U.S. Cl. CPC F16B 23/0007; B25B 13/485

(57) ABSTRACT

A screw fastening device includes a driver, a photographing portion, a transfer unit, a barycentric coordinate calculating portion, and a screw hole specifying portion. The driver fastens a screw. The photographing portion photographs a substrate. The transfer unit transfers the driver and photographing portion in front-rear and left-right directions. The screw fastening device specifies, a photographed image, screw fastening coordinates, moves the driver, using the transfer unit, to the position indicated by the screw fastening coordinates, and fastens the substrate to a frame. A mark is imparted to an inner side of a screw hole in the frame, such that the mark is distinguishable in the photographed image from the substrate and the frame. The barycentric coordinate calculating portion calculates barycentric coordinates of a position of the detected mark. The screw hole specifying portion specifies the screw fastening coordinates based on the calculated barycentric coordinates.

### INCORPORATION BY REFERENCE

This application is based upon and claims the benefit of priority from the corresponding Japanese Patent Application No. 2018-086579 filed on Apr. 27, 2018, the entire contents of which are incorporated herein by reference.

### BACKGROUND

The present disclosure relates to a screw fastening apparatus configured to fasten a screw to a screw hole that is detected by a camera, and a frame to which a substrate is fastened with screws.

When a screw fastening apparatus is configured to fasten, with screws, a substrate to a frame such as a metal sheet, there is known a technology that preregisters coordinate position data of a screw hole, installs the substrate at a specific position in advance, and fastens the screws according to the coordinate position data.

In addition, there is known a technology that preregisters coordinate position data of a screw hole to an automatic screw fastening apparatus, photographs, using a camera, an area (hereinafter referred to as a hole overlap area) where a screw attaching hole in a frame and a through hole in a substrate are overlapped, and detects an amount of misalignment from a regular position of the hole overlap area.

### SUMMARY

A screw fastening apparatus according to an aspect of the present disclosure includes a driver, a photographing portion, a transfer unit, a mark detecting portion, a barycentric coordinate calculating portion, and a screw hole specifying portion. The driver is configured to fasten a screw. The photographing portion is configured to photograph a substrate. The transfer unit transfers the driver and the photographing portion in front-rear and left-right directions. The screw fastening apparatus is configured to specify, based on an image photographed by the photographing portion, screw fastening coordinates that indicate a position where a screw is fastened, to move the driver, using the transfer unit, to the position indicated by the screw fastening coordinates, and to fasten, with screws, the substrate to a frame. A mark is imparted to an inner side of a screw hole in the frame, such that the mark is distinguishable from the substrate and the frame in the photographed image. The mark detecting portion detects the mark in the photographed image. The barycentric coordinate calculating portion calculates barycentric coordinates of a position of the mark that has been detected by the mark detecting portion. The screw hole specifying portion specifies the screw fastening coordinates, based on the barycentric coordinates that have been calculated by the barycentric coordinate calculating portion.

A frame according to an aspect of the present disclosure to which a substrate is fastened with one or more screws includes a mark imparted to an inner side of a screw hole, the mark having a color and design that are distinguishable from those of the substrate.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective diagram showing a configuration of a screw fastening apparatus according to an embodiment of the present disclosure.

FIGS. 2A-2C are diagrams showing an example of a mark imparted to a frame that is configured by a metal sheet.

FIGS. 3A-3C are diagrams showing an example of a mark imparted to a frame that is configured by resin.

FIG. 4 is a block diagram showing a configuration of the screw fastening apparatus shown in FIG. 1.

FIG. 5 is a flowchart showing a screw hole specifying process executed by the screw fastening apparatus shown in FIG. 1.

FIGS. 6A-6C are explanatory diagrams showing the screw hole specifying process executed by the screw fastening apparatus shown in FIG. 1.

FIGS. 7A-7C are explanatory diagrams showing the screw hole specifying process executed by the screw fastening apparatus shown in FIG. 1.

### DETAILED DESCRIPTION

Meanwhile, in a case where a screw is fastened, according to coordinate position data, to a substrate that is installed at a specific position, it is necessary to install the substrate at the specific position, and the installation takes time. In addition, in a case where an amount of misalignment from a regular position of a hole overlap area, where a screw hole in a frame and a through hole in the substrate are overlapped, is detected by photographing using a camera, although it is not necessary to install the substrate at the specific position, there is an issue of being unable to fasten a screw at a correct position, with respect to a screw hole that is detected by the camera. That is, since the substrate and the frame each have a thickness, when the camera and the screw hole are not positioned directly opposite of one another, the actual hole overlap area and the hole overlap area photographed by the camera are different in shape and position. Accordingly, when the amount of misalignment is detected based on the hole overlap area photographed by the camera, a position where the screw is fastened is not aligned with the actual hole overlap area. As a solution to this issue, a screw fastening apparatus 1 according to the present disclosure can fasten a screw at the correct position with respect to the screw hole that is detected by a photographing portion.

The following describes an embodiment of the present disclosure with reference to the accompanying drawings. It is noted that in the embodiment below, constituent structures having similar functions are denoted with the same character.

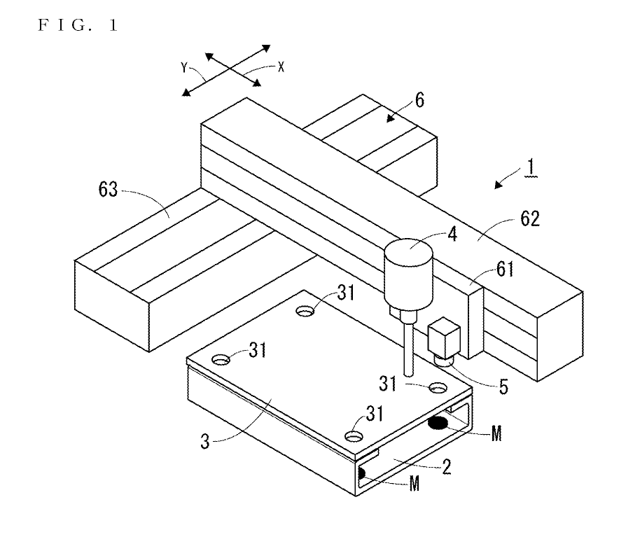

The screw fastening apparatus 1 according to the present disclosure shown in FIG. 1 is configured to fasten, with screws, a substrate 3 to a frame 2 that is made of a metal sheet or the like. The screw fastening apparatus 1 includes: a driver 4, for fastening screws, equipped with a bit that is rotatable, moveable vertically, and configured to engage with a screw; a camera 5 for photographing the substrate 3 to which the screw is fastened; and a transfer unit 6 for transferring the driver 4 and the camera 5 in front-rear and left-right directions.

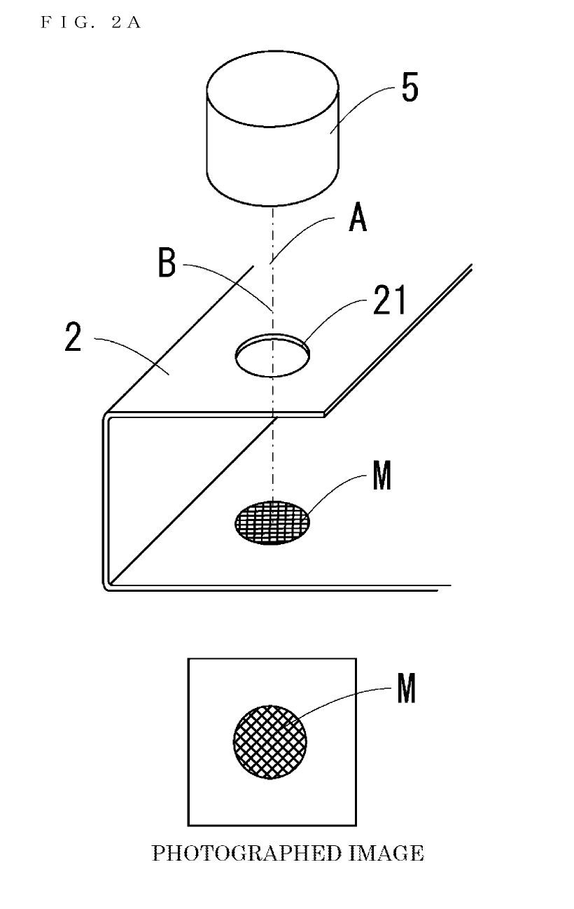

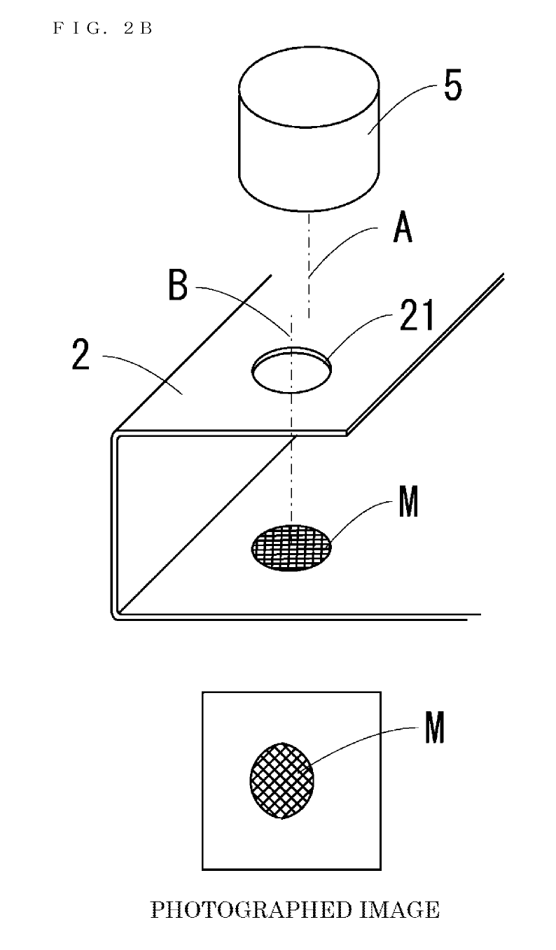

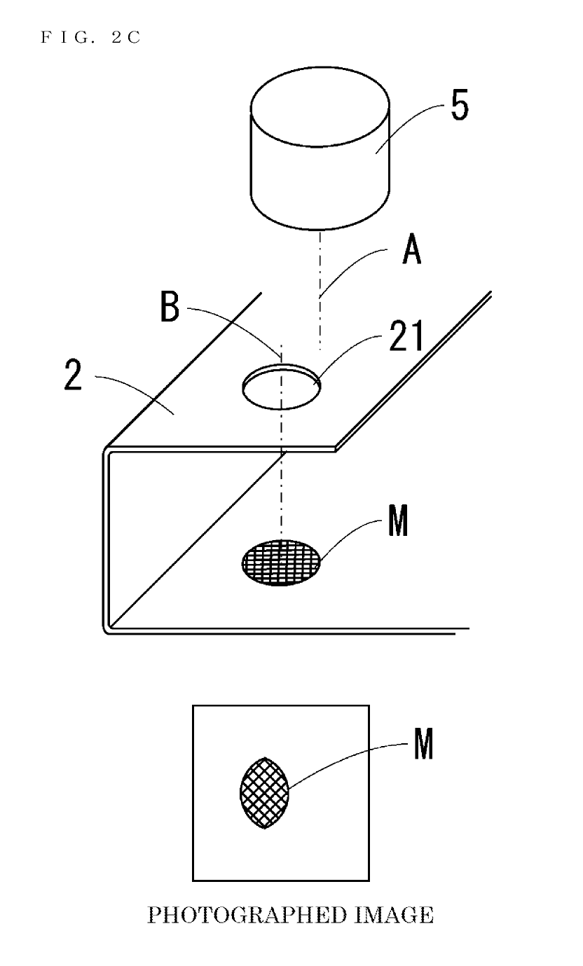

As shown in FIGS. 2A-2C, a mark M is imparted to an inner side of a screw hole 21 in the frame 2, on which the substrate 3 is fastened with screws. When the frame 2 is made of a metal sheet and the screw hole 21 is a through hole, as shown in FIGS. 2A-2C, the mark M is imparted to a surface of the frame 2 positioned on the inner side of the screw hole 21. The mark M is imparted having a color and design that can be distinguished from the color and design of the substrate 3. With this configuration, the mark M can be distinguished, by its color and design, from the substrate 3 and the frame 2 in an image photographed by the camera 5. The mark M may be an engraving or a drawing drawn by a marker.

The mark M has, for example, a circular shape substantially similar in diameter to the screw hole 21, and is imparted such that its center is aligned with a center axis B of the screw hole 21. With this configuration, as shown in FIG. 2A, an area of the mark M in the image photographed by the camera 5 is largest when an optical axis A of the camera 5 and the center axis B of the screw hole 21 in the frame 2 are aligned. In addition, as shown in FIG. 2B and FIG. 2C, the area of the mark M in the image photographed by the camera 5 becomes smaller as the optical axis A of the camera 5 and the center axis B of the screw hole 21 in the frame 2 become more misaligned.

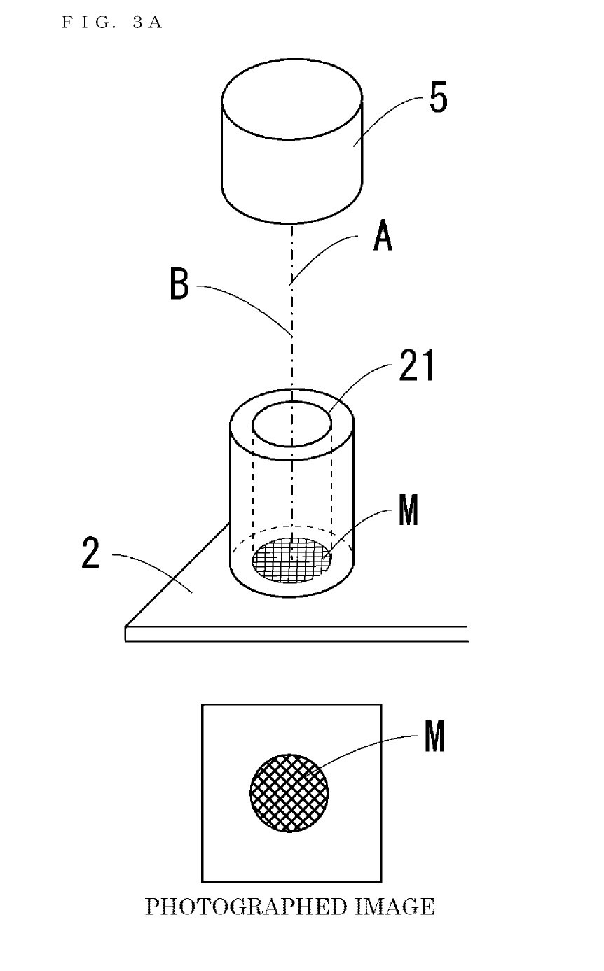

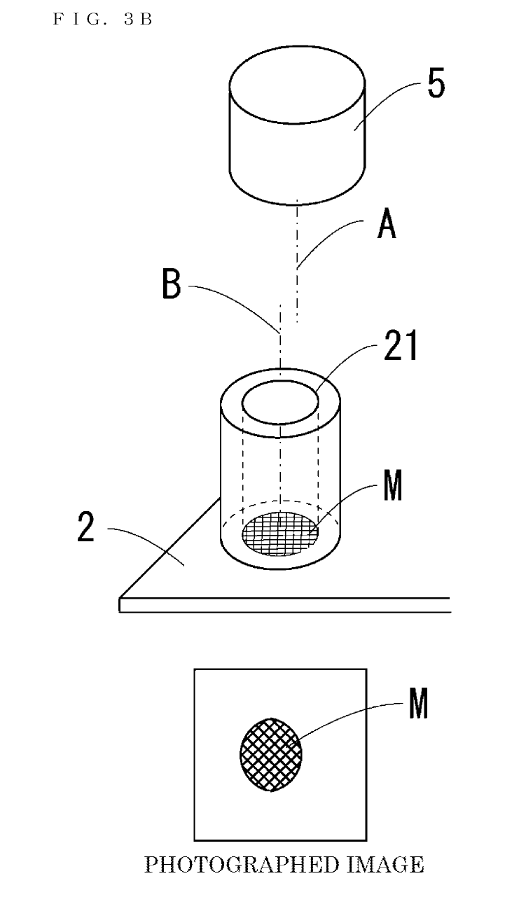

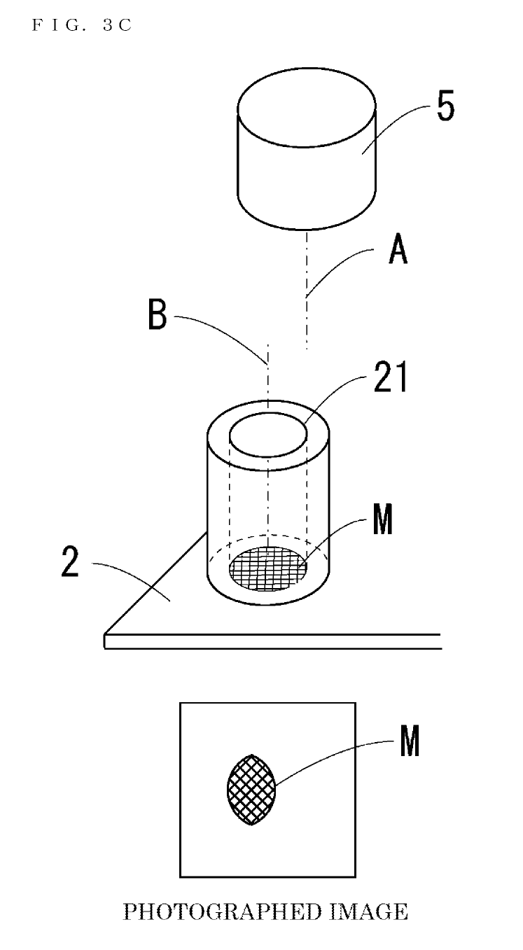

As shown in FIGS. 3A-3C, when the frame 2 is made with resin and the screw hole 21 is not a through hole, the mark M is imparted to a bottom surface on the inner side of the screw hole 21. The mark M may be formed by pouring paint or the like into the screw hole 21. In this case, as shown in FIG. 3A, the area of the mark M in the image photographed by the camera 5 is largest when the optical axis A of the camera 5 and the center axis B of the screw hole 21 in the frame 2 are aligned. In addition, as shown in FIG. 3B and FIG. 3C, the area of the mark M in the image photographed by the camera 5 becomes smaller as the optical axis A of the camera 5 and the center axis B of the screw hole 21 in the frame 2 become more misaligned.

The driver 4 includes a rotational drive portion, such as a motor, for rotating the bit, and an elevating drive portion, such as a cylinder, for moving the bit vertically. It is noted that the driver 4 may have any configuration as long as it includes a screw fastening function.

The camera 5 is a photographing means such as a CCD camera that photographs a specific area in the substrate 3 from above.

The transfer unit 6 includes a first transport portion 61 to which the driver 4 and the camera 5 are fixed, a second transport portion 62 for movably supporting the first transport portion 61 in an X-direction shown in FIG. 1, and a fixing portion 63 for moveably supporting the second transport portion 62 in a Y-direction shown in FIG. 1. In addition, the transfer unit 6 includes a driving portion for moving the first transport portion 61 in the X-direction, and a driving portion for moving the second transport portion 62 in the Y-direction, but both of which are not shown. With this configuration, the first transport portion 61, that is, the driver 4 and the camera 5, can be transferred to a position of any coordinate of the substrate 3.

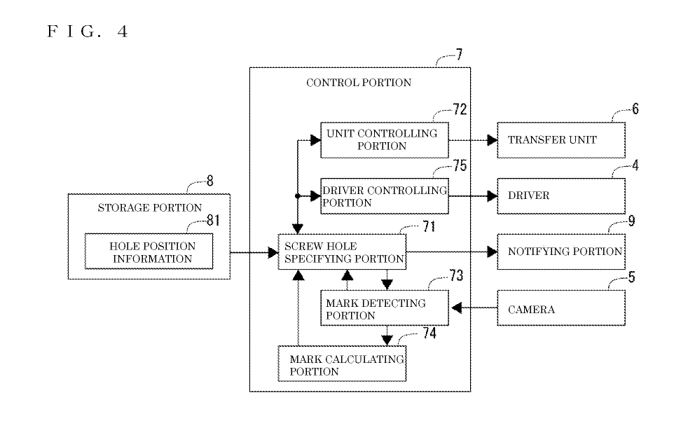

As shown in FIG. 4, the screw fastening apparatus 1 includes a control portion 7 that is connected to the driver 4, the camera 5, and the transfer unit 6. In addition, the control portion 7 is connected to a storage portion 8 and a notifying portion 9.

The storage portion 8 is a storage means such as a semiconductor memory or the like, and a position of a through hole 31 (the screw hole 21 in the frame 2) in the substrate 3 is stored therein as hole position information 81.

The notifying portion 9 is a display means such as a liquid crystal display and a voice output means such as a speaker, and is configured to notify an error to a user.

The control portion 7 is an arithmetic processing circuit such as a microcomputer that includes a CPU (Central Processing Unit), a ROM (Read Only Memory), and a RAM (Random Access Memory). A control program for controlling a process of the screw fastening apparatus 1 is stored in the ROM. The control portion 7, by reading the control program from the ROM and decompressing the control program in the RAM, functions as a screw hole specifying portion 71, a unit controlling portion 72, a mark detecting portion 73, a mark calculating portion 74, and a driver controlling portion 75, and thereby controls the screw fastening apparatus 1.

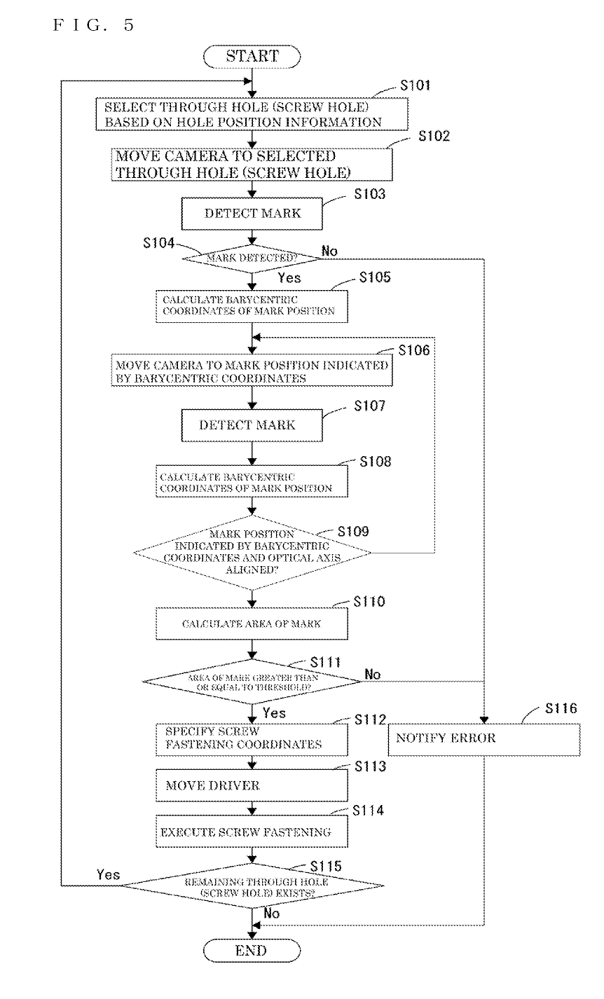

In the following, a screw specifying process of the screw fastening apparatus 1 is described with reference to FIG. 5 to FIG. 7C.

When the control portion 7 receives a screw fastening command, it functions as the screw hole specifying portion 71. The screw hole specifying portion 71, based on the hole position information 81 stored in the storage portion 8, selects one through hole 31 (screw hole 21 in the frame 2) in the substrate 3 to which a screw has not been fastened (step S101).

Next, the control portion 7 functions as the unit controlling portion 72 for controlling movement of the transfer unit 6, and moves the camera 5 to the through hole 31 (screw hole 21) that has been selected in step S101 (step S102). It is noted that coordinates of the position of the center axis B of the through hole 31 (screw hole 21) are set in the hole position information 81, and the unit controlling portion 72 moves the camera 5 so that the center axis B of the through hole 31 (screw hole 21) and the optical axis A of the camera 5 are aligned.

Next, the control portion 7 functions as the mark detecting portion 73, and detects the mark M in an image photographed by the camera 5 (step S103). Since the mark M is formed as an engraving or a drawing by a marker such that it is distinguishable from the substrate 3 and the frame 2, the mark M can be easily detected by image analysis.

Next, the mark detecting portion 73 determines whether or not the mark M has been detected in step S103 (step S104). It is noted that in the present embodiment, the substrate 3 and frame 2 are not required to be positioned with high precision, and their positions may be determined roughly. For this reason, the mark M may not be detected depending on the positions of the substrate 3 and frame 2. When it is determined in step S104 that the mark M has not been detected, the mark detecting portion 73 causes the notifying portion 9 to output a position misalignment error notifying that the positions of the substrate 3 and frame 2 are too misaligned (step S116), and ends the screw hole specifying process.

It is noted that in the present embodiment, the camera 5 is moved based on the hole position information 81, but the camera 5 may photograph an image while being moved along a specific route by the transfer unit 6, and the mark M may be detected from this image. In this case, it is not necessary to prepare the hole position information 81 in advance.

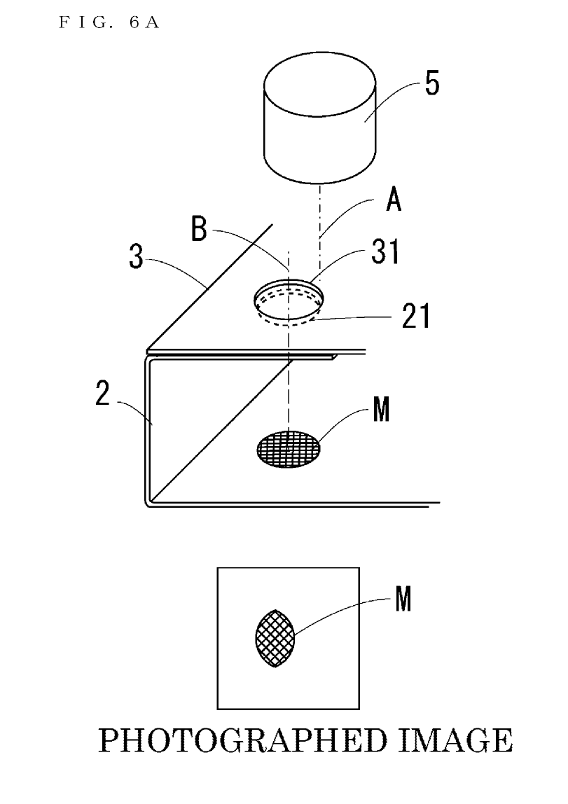

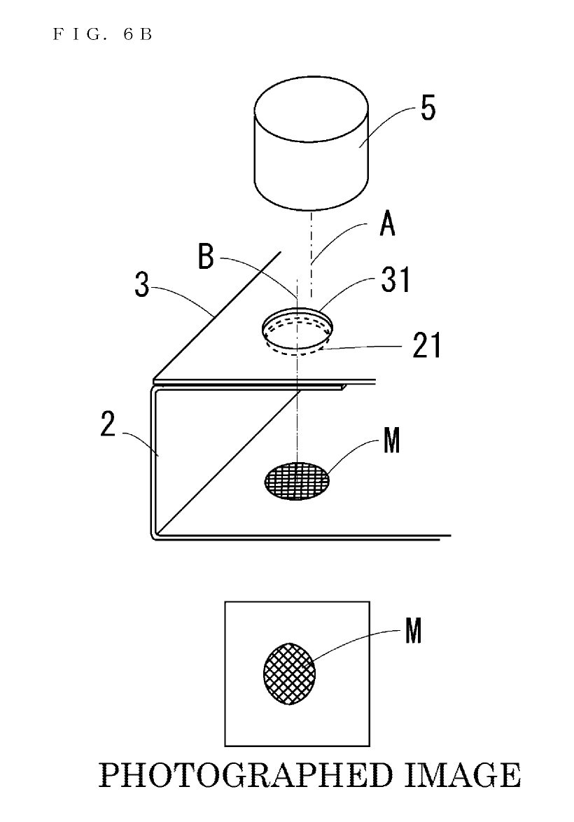

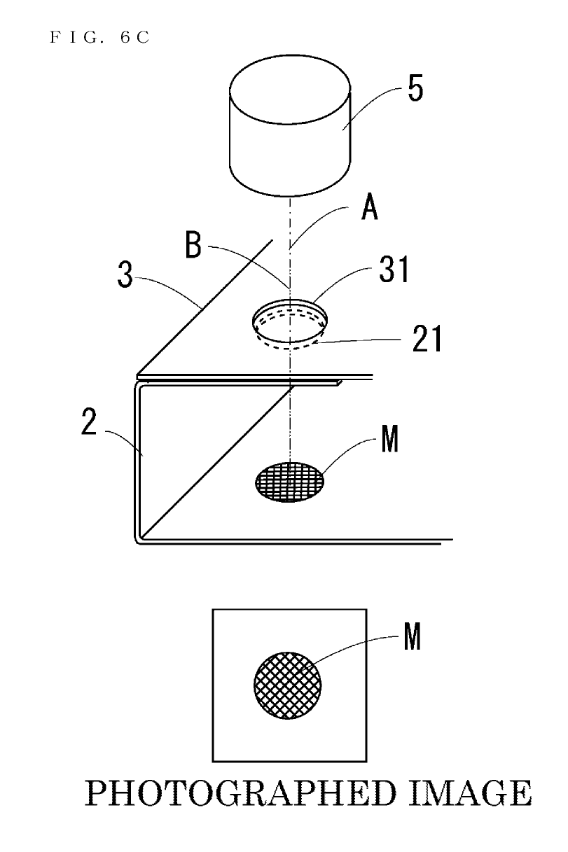

When it is determined in step S104 that the mark M has been detected, the mark calculating portion 74 calculates barycentric coordinates C indicating the position of the mark M that has been detected in step S103 (step S105). FIG. 6A shows an example where the mark calculating portion 74 has calculated barycentric coordinates C₁ of the position of the mark M.

Next, the screw hole specifying portion 71 causes the unit controlling portion 72 to move the camera 5 so that the optical axis A is aligned with the position indicated by the barycentric coordinates C that have been calculated in step S105 (step S106). FIG. 6B shows an example of the camera 5 that has been moved to the position indicated by the barycentric coordinates C₁ of the mark M.

Then, the mark detecting portion 73 detects the mark M from the image photographed by the camera 5 (step S107), and the mark calculating portion 74 calculates the barycentric coordinates C of the position of the mark M detected in step S107 (step S108).

Next, the mark detecting portion 73 determines whether or not the position indicated by the barycentric coordinates C of the mark M calculated in step S108, and the optical axis A of the camera 5 are aligned (step S109).

When it is determined in step S109 that the position indicated by the barycentric coordinates C of the mark M and the optical axis A of the camera 5 are not aligned, the process returns to step S106, and steps S106 to S108 are repeated until it is determined in step S109 that the position indicated by the barycentric coordinates C of the mark M and the optical axis A of the camera 5 are aligned. It is noted that during actual control of the alignment determination in step S109, it is ideal to determine the alignment with enough precision that a screw can be fastened accurately, and thus it is determined that the position indicated by the barycentric coordinates C of the mark M and the optical axis A of the camera 5 are aligned as long as they are positioned within a specific distance from one another.

FIG. 6B shows an example where barycentric coordinates C₂ indicating the position of the mark M has been calculated by the mark calculating portion 74. When the position indicated by the barycentric coordinates C₂ of the mark M and the optical axis A of the camera 5 are not aligned, steps S106 to S108 are repeated until the position indicated by barycentric coordinates Cₙ of the mark M and the optical axis A of the camera 5 are determined to be aligned, as shown in FIG. 6C.

When the through hole 31 in the substrate 3 and the screw hole 21 in the frame 2 are aligned as shown in FIG. 6C, that is, when the through hole 31 is viewed from directly above and the entirety of the screw hole 21 is visible, the optical axis A of the camera 5 and the center axis B of the screw hole 21 are aligned by aligning the optical axis A of the camera 5 with the position indicated by the barycentric coordinates Cₙ of the mark M.

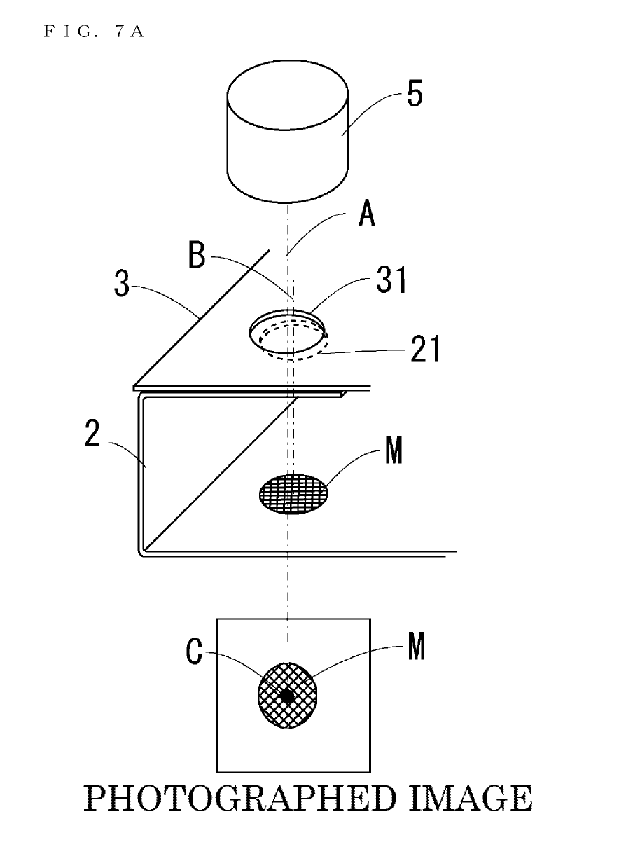

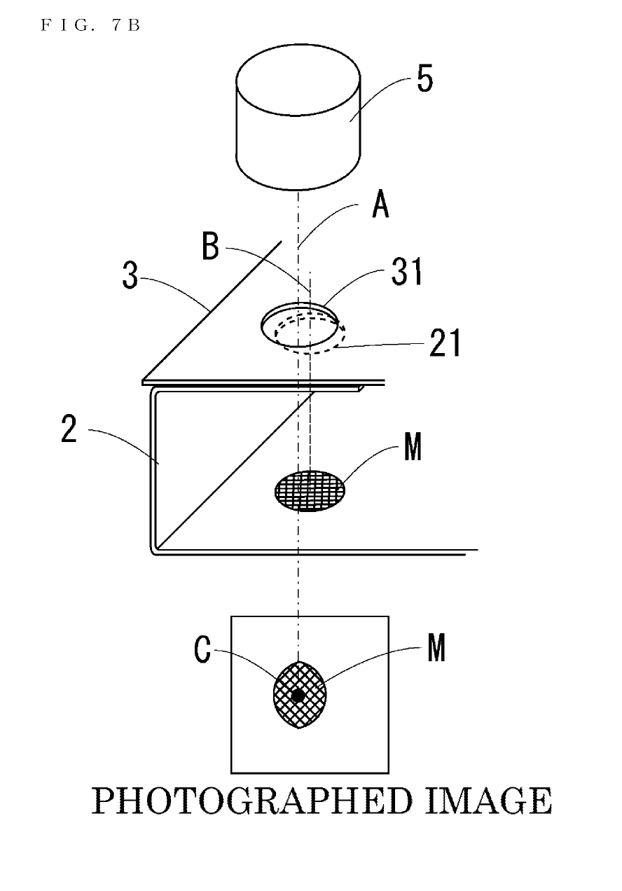

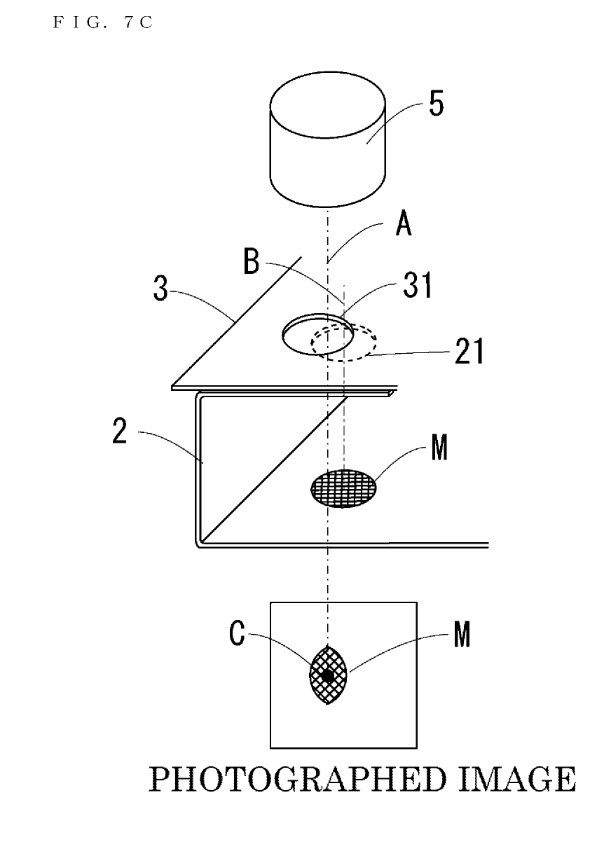

It is noted that, as shown in FIG. 7A, when the through hole 31 in the substrate 3 and the screw hole 21 in the frame 2 are not aligned, that is, when the through hole 31 is viewed from directly above and a portion of the screw hole 21 is hidden, even if the position indicated by the barycentric coordinates C of the mark M and the optical axis A of the camera 5 are aligned, the optical axis A of the camera 5 and the center axis B of the screw hole 21 are not aligned. As shown in FIG. 7B and FIG. 7C, the more the through hole 31 in the substrate 3 and the screw hole 21 in the frame 2 are misaligned, the smaller the area of the mark M in the photographed image, and the more the optical axis A of the camera 5 and the center axis B of the screw hole 21 are misaligned.

When the position indicated by the barycentric coordinates C of the mark M and the optical axis A of the camera 5 are determined to be aligned in step S109, the mark calculating portion 74 calculates the area of the mark M (step S110), and the screw hole specifying portion 71 determines whether or not the area of the mark M is greater than or equal to a preset area threshold (step S111). When it is determined in step S111 that the area of the mark M is greater than or equal to the preset area threshold, this means that an amount of misalignment between the optical axis A of the camera 5 and the center axis B of the screw hole 21 is less than or equal to a specific value. Accordingly, the screw hole specifying portion 71 specifies the coordinates of the optical axis A of the camera 5 as screw fastening coordinates (step S112).

Next, the screw hole specifying portion 71 causes the unit controlling portion 72 to move the driver 4 to the position indicated by the screw fastening coordinates specified in step S112 (step S113), and causes the driver controlling portion 75 to execute screw fastening (step S114).

Next, the screw hole specifying portion 71 determines whether or not any remaining through holes 31 (screw holes 21), to which a screw has not been fastened, exist (step S115). When it is determined that there is a remaining through hole 31 (screw hole 21), the process returns to step S101, and when it is determined that there are no remaining through holes 31 (screw holes 21), the screw hole specifying process ends.

When it is determined in step S111 that the area of the mark M is less than the preset area threshold, this means that the amount of misalignment between the optical axis A of the camera 5 and the center axis B of the screw hole 21 is greater than the specific value. Accordingly, the screw hole specifying portion 71 causes the notifying portion 9 to output the position misalignment error notifying that the positions of the substrate 3 and frame 2 are too misaligned (step S116), and ends the screw hole specifying process.

As described above, according to the present embodiment, the screw fastening apparatus 1 includes the driver 4 for fastening screws, the camera 5 for photographing the substrate 3, and the transfer unit 6 for transferring the driver 4 and the camera 5 in front-rear and left-right directions. In the screw fastening apparatus 1, the screw fastening coordinates that indicate a position where a screw is fastened are specified based on the image photographed by the camera 5, the driver 4 is moved by the transfer unit 6 to the position indicated by the screw fastening coordinates, and the frame 2 is fastened with screws to the substrate 3. On the frame 2 on the inner side of the screw hole 21, the mark M is imparted distinguishably from the substrate 3 and the frame 2 in the photographed image. The screw fastening apparatus 1 further includes the mark detecting portion 73 for detecting the mark M in the photographed image, a barycentric coordinate calculating portion (the mark calculating portion 74) for calculating the barycentric coordinates of the mark M detected by the mark detecting portion 73, and the screw hole specifying portion 71 for specifying the screw fastening coordinates based on the barycentric coordinates that have been calculated by the mark calculating portion 74. With this configuration, a position near the center axis B of the screw hole 21 is specified by the screw fastening coordinates, and thus a screw can be fastened accurately to the screw hole 21 detected by the camera 5.

Furthermore, the screw fastening apparatus 1 according to the present embodiment includes an area calculating portion (the mark calculating portion 74) for calculating the area of the mark M that has been detected by the mark detecting portion 73, and the notifying portion 9 for notifying an error. When the area of the mark M calculated by the mark calculating portion 74 is greater than or equal to the preset area threshold, the screw hole specifying portion 71 specifies the barycentric coordinates as the screw fastening coordinates, and when the area of the mark M calculated by the mark calculating portion 74 is less than the preset area threshold, the screw hole specifying portion 71 causes the notifying portion 9 to output the error. With this configuration, it is possible to determine whether or not to execute screw fastening in response to the amount of misalignment between the through hole 31 in the substrate 3 and the screw hole 21 in the frame 2.

Furthermore, in the present embodiment, the screw hole specifying portion 71 repeats a cycle of detecting the mark M using the mark detecting portion 73 and calculating the barycentric coordinates of its position using the mark calculating portion 74, until, after moving the optical axis A of the camera 5 using the transfer unit 6 to the position indicated by the barycentric coordinates, the position indicated by the barycentric coordinates of the mark M detected by the mark detecting portion 73 and the optical axis A of the camera 5 are aligned. The barycentric coordinates C indicating the position of the mark M aligned with the optical axis A of the camera 5 are specified as the screw fastening coordinates. With this configuration, it is possible to specify screw fastening coordinates that roughly match the position of the center axis B of the screw hole 21.

Furthermore, in the present embodiment, the mark detecting portion 73 detects the mark M from an image photographed by the camera 5, as the camera 5 is moved by the transfer unit 6 along the specific route. With this configuration, it is not necessary to preliminarily prepare the hole position information 81 in which coordinates of the center axis B of the through hole 31 (screw hole 21) are set.

Furthermore, in the present embodiment, in the case that the screw hole 21 is a through hole, the mark M is imparted to the frame 2 that is positioned on the inner side of the screw hole 21. This allows for the mark M to be imparted easily to the inner side of the screw hole 21 that is a through hole.

Furthermore, in the present embodiment, when the screw hole 21 is not a through hole, the mark M is imparted to the bottom surface on the inner side of the screw hole 21. This allows for the mark M to be imparted easily to the inner side of the screw hole 21 that is not a through hole.

Furthermore, in the present embodiment, the mark M is imparted so that when the optical axis A of the camera 5 and the center axis B of the screw hole 21 are aligned, the area of the mark M in the photographed image is largest, and the more misaligned that the optical axis A of the camera 5 and the center axis B of the screw hole 21 are, the smaller the area is. With this configuration, it is possible to accurately determine whether or not to execute screw fastening in response to the amount of misalignment between the through hole 31 in the substrate 3 and the screw hole 21 in the frame 2.

It is noted that numbers, positions, shapes, and the like of the constituent structures described above are not limited to those according to the present embodiment, and other suitable numbers, positions, shapes, and the like may be used for application of the present disclosure. It is further noted that in the accompanying drawings, constituent structures having similar functions are denoted with the same character.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A screw fastening apparatus, comprising:
a driver configured to fasten a screw;
a photographing portion configured to photograph a substrate; and
a transfer unit configured to transfer the driver and the photographing portion in front-rear and left-right directions, wherein
the screw fastening apparatus is configured to specify, based on an image photographed by the photographing portion, screw fastening coordinates that indicate a position where a screw is fastened, to move the driver, using the transfer unit, to the position indicated by the screw fastening coordinates, and to fasten, with screws, the substrate to a frame,
a mark is imparted, to an inner side of a screw hole in the frame, such that the mark is distinguishable in the photographed image from the substrate and the frame, and
the screw fastening apparatus further comprises:
a mark detecting portion configured to detect the mark in the photographed image;
a barycentric coordinate calculating portion configured to calculate barycentric coordinates of a position of the mark that has been detected by the mark detecting portion; and
a screw hole specifying portion configured to specify the screw fastening coordinates, based on the barycentric coordinates that have been calculated by the barycentric coordinate calculating portion.

2. The screw fastening apparatus according to claim 1, further comprising
an area calculating portion configured to calculate an area of the mark that has been detected by the mark detecting portion, and
a notifying portion configured to notify an error, wherein
when the area of the mark calculated by the area calculating portion is greater than or equal to a preset area threshold, the screw hole specifying portion specifies the barycentric coordinates as the screw fastening coordinates, and when the area of the mark calculated by the area calculating portion is less than the preset area threshold, the screw hole specifying portion causes the notifying portion to output the error.

3. The screw fastening apparatus according to claim 1, wherein
the screw hole specifying portion repeats a cycle of detecting the mark using the mark detecting portion and calculating the barycentric coordinates using the barycentric coordinate calculating portion, until, after moving an optical axis of the photographing portion using the transfer unit to the position indicated by the barycentric coordinates, the position indicated by the barycentric coordinates of the mark that has been detected by the mark detecting portion is aligned with the optical axis of the photographing portion, and
the screw hole specifying portion specifies the barycentric coordinates indicating the position aligned with the optical axis of the photographing portion, as the screw fastening coordinates.

4. The screw fastening apparatus according to claim 1, wherein
the photographed image from which the mark detecting portion detects the mark is photographed as the photographing portion is moved by the transferring unit along a specific route.

5. The screw fastening apparatus according to claim 1, wherein
when the screw hole is a through hole, the mark is imparted to a surface of the frame that is positioned on the inner side of the screw hole.

6. The screw fastening apparatus according to claim 1, wherein
when the screw hole is not a through hole, the mark is imparted to a bottom surface that is positioned on the inner side of the screw hole.

7. The screw fastening apparatus according to claim 1, wherein
an area of the mark in the photographed image is largest when an optical axis of the photographing portion is aligned with a center axis of the screw hole, and the more the optical axis of the photographing portion and the center axis of the screw hole are misaligned, the smaller the area of the mark in the photographed image is.

8. A frame to which a substrate is fastened with one or more screws, the frame comprising:
a mark imparted to an inner side of a screw hole, the mark having a color and design that are distinguishable from those of the substrate.
